(19) United States
(12) Patent Application Publication
(10) Pub. No.: US 2008/0076435 A1
(43) Pub. Date: Mar. 27, 2008

(54) Wireless Backhaul

(75) Inventors: Li-Wei Chen, Watertown, MA (US); Carlos Cabrera-Mercader, Cambridge, MA (US); Brian Fallik, Somerville, MA (US)

Correspondence Address: FISH & RICHARDSON PC, P.O. BOX 1022, MINNEAPOLIS, MN, 55440-1022, US

(73) Assignee: VANU, INC., Cambridge, MA (US)

(21) Appl. No.: 11/534,429

(22) Filed: Sep. 22, 2006

(51) Int. Cl. H04Q 7/20

(52) U.S. Cl. 455/445

(57) ABSTRACT

Methods, systems, devices, and computer program products for backhaul of wireless transmissions are disclosed.

### TECHNICAL FIELD

The following description relates to wireless backhaul.

### BACKGROUND

As shown in FIG. 1, in a cellular system 10, voice, data, and signaling traffic is sent between mobile devices 12, 14, and 16 and a base station 20 located at a cell tower site 18. The voice, data, and signaling traffic is backhauled from the base station 20 at the cell tower site 18 to a base station controller 26 and a mobile switching center 28. In general, backhaul refers to getting the voice, data, and signaling traffic to the core network, e.g., from a base station 20 located at the cell tower site 18 to the base station controller 26 and from the base station controller 26 to the base station 20. Most backhaul takes place over dedicated T1 lines 22 or using microwave relay, which have guaranteed bandwidth and latency that can be used to support real time voice calls. Unfortunately, T-1 lines and microwave relays result in significant operating expenses for network operators. Monthly costs for T-1 lines are generally hundreds, and may be thousands, of dollars. Microwave relays typically result in additional charges to the operator primarily as a result of the need to lease space for additional antennas and feedlines on cellular towers. In addition, microwave relays use directional antennas that can become misaligned, interrupting service and resulting in additional operational costs to restore alignment.

### SUMMARY

In some aspects, a method for backhaul of wireless transmissions includes receiving, at a first base station, a wireless transmission from a mobile device, the wireless transmission using a first wireless protocol. The method also includes forwarding the transmission from the first base station to a second base station using a second wireless protocol, the second wireless protocol being different than the first wireless protocol.

Embodiments can include one or more of the following. The method can also include processing the wireless transmission at the first base station. The method can also include forwarding a received transmission from the second base station to a base station controller. Forwarding the received transmission to the base station controller can include forwarding the received transmission over a wired line. The wired line can be a T1 line.

The first base station can be a base station and the second base station can be a hub station. The hub station can be communicatively coupled with two or more base stations. The method can also include receiving, at the first base station, a wireless transmission from the second base station (the wireless transmission using the second wireless protocol) and forwarding the transmission from the first base station to the mobile device using the first wireless protocol.

The method can also include processing the wireless transmission from the second base station at the first base station. The method can also include allocating a first channel of the first base station for communications between the first base station and the mobile device and allocating a second channel of the first base station for communications between the first base station and the second base station.

The method can also include providing a jitter buffer at the second base station and using the jitter buffer to compensate for jitter introduced by forwarding the processed transmission from the first base station to a second base station.

The method can also include determining, at the first base station, a priority of the received transmission and forwarding the transmission based on the determined priority. Determining a priority can include assigning a first priority to transmissions including at least one of signaling data and control data and assigning a second priority to transmissions including voice data where the first priority is greater than the second priority. The method can also include applying a data acknowledgement and retransmission scheme to transmissions assigned the first priority. The wireless transmission can be a transmission from a cellular telephone.

In some aspects, a system for backhaul of wireless can include a base station. The base station can be configured to receive a wireless transmission from a mobile device, the wireless transmission using a first wireless protocol. The base station can be further configured to forward the received transmission using a second wireless protocol, the second wireless protocol being different than the first wireless protocol.

Embodiments can include one or more of the following.

The base station can be further configured to process the wireless transmission. The base station can be further configured to determine, at the first base station, a priority of the received transmission and forward the transmission based on the determined priority.

The base station can be further configured to assign a first priority to transmissions including at least one of signaling data and control data and assign a second priority to transmissions including voice data. The first priority can be greater than the second priority. The base station can be further configured to apply a data acknowledgement and retransmission scheme to transmissions assigned the first priority.

The system can also include a hub station. The hub station can be configured to receive a wireless transmission from the base station and forward the received transmission to a base station controller over a wired line. The hub station can be communicatively coupled with two or more base stations.

In some aspects, a computer program product can be tangibly embodied on an information carrier. The computer program product can include instructions to cause a machine to receive at a base station a wireless transmission from a mobile device, the wireless transmission using a first wireless protocol. The computer program product can also include instructions to forward the transmission from the base station to a hub station using a second wireless protocol, the second wireless protocol being different than the first wireless protocol.

Embodiments can include one or more of the following.

The computer program product can include instructions to cause the machine to process the wireless transmission. The hub station can be communicatively coupled with two or more base stations. The computer program product can include instructions to cause the machine to determine, at the first base station, a priority of the received transmission and forward the transmission based on the determined priority.

The computer program product can include instructions to cause the machine to assign a first priority to transmissions including at least one of signaling data and control data, assign a second priority to transmissions including voice data. The first priority can be greater than the second priority. The computer program product can also include instructions to apply a data acknowledgement and retransmission scheme to transmissions assigned the first priority.

In some aspects, a method can include, between a base station that communicates with mobile devices and a base station controller, carrying bidirectional call data using a bidirectional wireless hop.

Embodiments can include one or more of the following.

The bidirectional wireless hop can communicate data using a protocol that is different than the protocol used to communicate with the mobile devices. The method can also include assigning a first priority to transmissions received by the bidirectional wireless hop that include at least one of signaling data and control data. The method can also include assigning a second priority to transmissions received by the bidirectional wireless hop that include voice data. The first priority can be greater than the second priority. The method can also include applying a data acknowledgement and retransmission scheme to transmissions assigned the first priority.

In some aspects, a method for backhaul of wireless transmissions includes wirelessly routing information to a particular base station of a plurality of base stations based on physical layer information.

Embodiments can include one or more of the following.

Each base station of the plurality of base stations can wirelessly communicate with a hub station using a unique frequency. The physical layer information can include a transmission frequency. The physical layer information can include a timeslot of transmission. The physical layer information can include an orthogonal code.

Routing information to a particular base station of a plurality of base stations based on physical layer information can include receiving at the hub station a transmission from a base station controller, determining which base station to route the transmission to by parsing an address included in the transmission, determining a transmission frequency associated with the determined base station, and routing the transmission to the determined base station using the determined transmission frequency. Routing information to a particular base station of a plurality of base stations based on physical layer information can include routing a first wireless transmission from a hub station to a first base station using a first frequency associated with the first base station and routing a second wireless transmission from the hub station to a second base station using a second frequency associated with the second base station, the second frequency being different from the first frequency.

In some aspects, a system for backhaul of wireless transmissions can include a hub station in wireless communication with two or more base stations. The hub station can be configured to route wireless transmissions to the two or more base stations using two or more different frequencies, the two or more different frequencies being associated with particular ones of the two or more base stations.

Embodiments can include one or more of the following.

The hub station can include an input configured to receive transmissions from a base station controller using a wired communication link. The hub station can be configured to receive a transmission from the base station controller using a wired link, determine which base station of the one or more base stations to send the transmission to, and send the transmission to the determined base station using a particular frequency associated with the determined base station. The hub station can be configured to route a first wireless transmission intended for a first base station of the one or more base stations to the first base station using a first frequency and route a second wireless transmission intended for a second base station of the one or more base stations to the second base station using a second frequency, the second frequency being different from the first frequency.

In some aspects a method for backhaul of wireless transmissions includes routing a first wireless transmission from a hub station to a first base station using a first frequency associated with the first base station and routing a second wireless transmission from a hub station to a second base station using a second frequency associated with the second base station, the second frequency being different from the first frequency.

Embodiments can include one or more of the following.

The method can include receiving at the hub station a transmission from a base station controller, determining which base station to route the transmission to by parsing an address included in the transmission, determining a frequency associated with the determined base station, and routing the transmission to the determined base station using the determined frequency.

### BRIEF DESCRIPTION OF THE DRAWINGS

FIG. 1 is a block diagram of a network.

FIG. 2 is a block diagram of a network.

FIG. 3 is a block diagram of a base station in communication with a mobile unit and a hub station.

FIG. 4 is a flow chart of a signal forwarding process.

FIG. 5 is a flow chart of a retransmission process.

FIG. 6 is a block diagram of a hub-and-spokes network.

FIG. 7 is a block diagram of a hub-and-spokes network with multiple hub stations.

FIG. 8 is a block diagram of multiple base stations operating at different frequencies.

FIG. 9 is a block diagram of multiple base stations operating at different frequencies.

### DETAILED DESCRIPTION

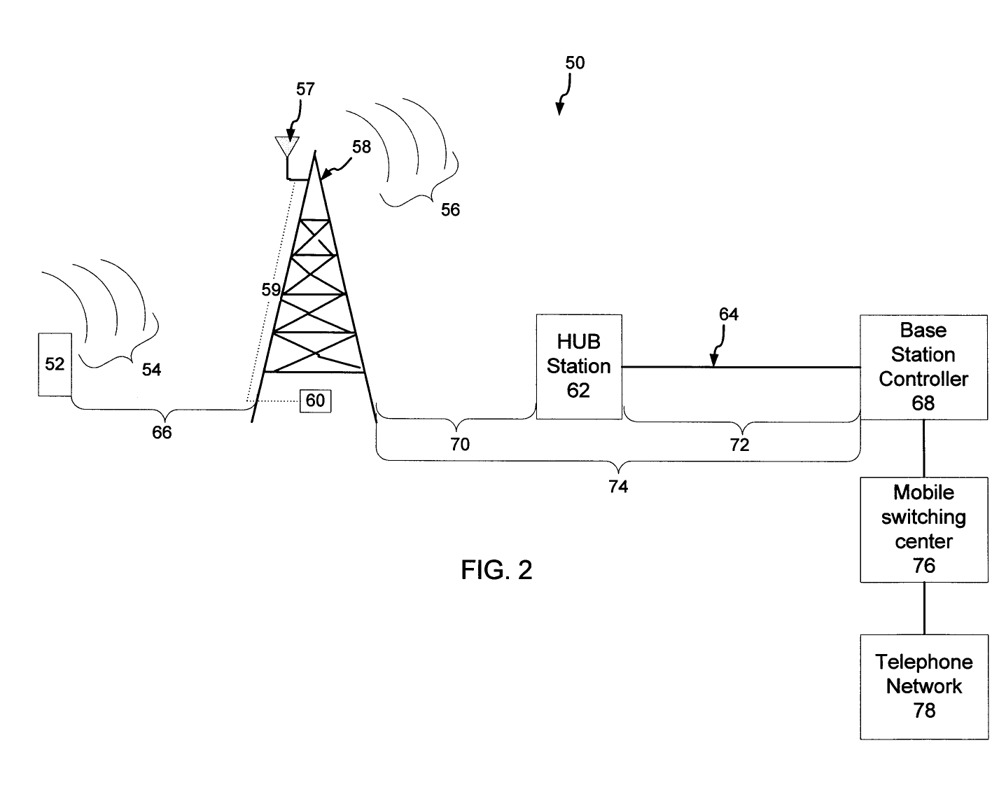

Referring to FIG. 2, a system 50 includes a mobile unit 52, a base station 60, a hub station 62, and a base station controller 68. The base station 60 communicates wireless signals, e.g., wireless voice signals and/or wireless data signals 54, from and to mobile unit 52 and backhauls the wireless signals via the hub station 62 and backhaul link 64 to a mobile switching center 76 connected to the base station controller 68 via T-1 line or other method.

In operation, the mobile unit 52 transmits wireless signals 54 to the base station 60. More particularly, an antenna 57 receives the wireless signals 54 from the mobile unit 52 and transmits the signals to the base station 60 using a feed-line 59. The base station 60 processes the wireless signals from mobile unit 52 and sends the processed wireless signals 56 to the hub station 62. The base station 60 and the hub station 62 communicate using a wireless link 70 (as described below). After receiving wireless signals from the base station 60, the hub station 62 routes the processed wireless signals to the base station controller 68 using a wired communication link 64 (which may be, e.g., the Ethernet or dedicated T-1 lines or which may be a wireless link such as a microwave relay). The base station controller 68 routes the processed signals to a mobile switching center 76 which routes the communication to other subscribers on the same network or other telephones via the public switched telephone network 78. Signals can also be sent in the other direction from the public switched telephone network 78 to the mobile unit 52 using the base station controller 68, hub station 62, and base station 60.

The process for transporting signals in either direction between the base station 60 (which receives the signal from the mobile unit 52) and the base station controller 68 is referred to as “backhaul.” In system 50, the backhaul link 74 includes the wireless link 70 between the base station 60 and the hub station 62 and the wired link 72 between the hub station 62 and the base station controller 68.

In order to reduce the cost of installing, configuring, and/or maintaining a system for cellular backhaul, the base station 60 communicates wirelessly with the base station controller 68 through the hub station 62 rather than being directly connected to the base station controller 68. It is believed such a configuration can reduce the cost of cellular backhaul because the wireless base station 60 provides a method for the mobile unit 52 to communicate with the core of the network without requiring a wireline (e.g., a T1 line) or directional wireless link (e.g., a microwave relay) to be connected to each base station that receives wireless communications from the mobile unit 52.

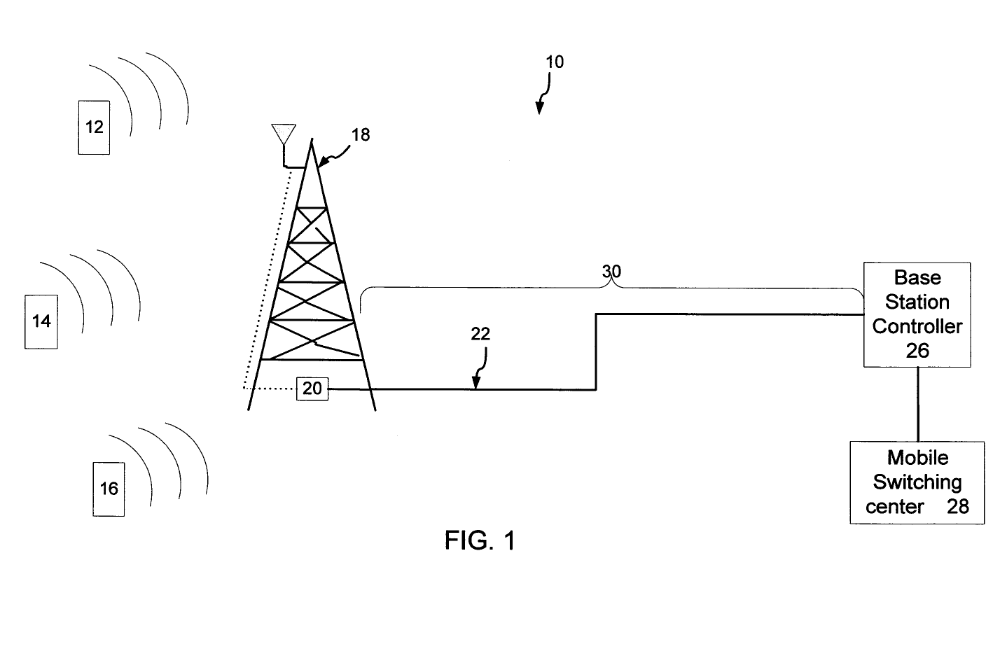

For example, systems which do not utilize such a wireless backhaul link between a base station 60 and a hub station 62 to relay information often have a T1 or microwave link directly from the base station that receives the wireless signal to the base station controller (e.g., as shown in FIG. 1). Such a system can be expensive to configure and maintain. For example, in some circumstances, the cost associated with installing and/or leasing T1 lines and microwave links to connect to each base station can be high enough to prevent deployment of a wireless infrastructure in rural areas where the volume of usage can be significantly lower compared to the volume of usage for urban areas. The high operating expenses of T1 and microwave links can even prevent the construction of base stations in areas where the network usage is not likely to cover the expense of operation for the base station.

By replacing the link 30 in FIG. 1 with a base station 60 that communicates wirelessly with a hub station 62 (e.g., as shown in FIG. 2), additional base stations can be operated at a lower cost than the cost typically associated with the operation of a base station.

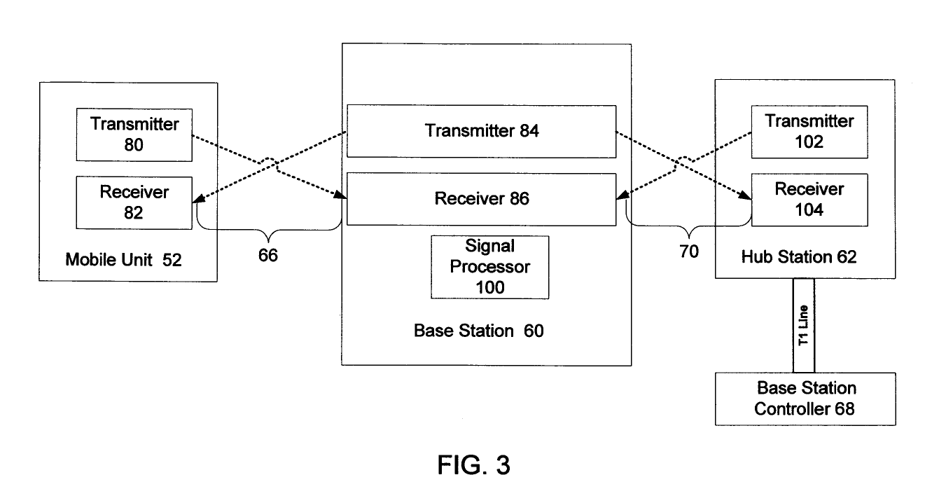

FIG. 3 shows the communication between the mobile unit 52 and the base station 60 over a wireless link 66 and the communication between base station 60 and hub station 62 over a wireless link 70. Mobile unit 52 includes a transmitter 80 and a receiver 82 configured to send and receive wireless signals over the wireless link 66. The wireless signals sent over wireless link 66 can be based on a standard wireless protocol such as code division multiple access (CDMA, including CDMA 1xRTT and CDMA EvDO), IS-136 time division multiple access (TDMA), global system for mobile communications (GSM), integrated Digital Enhanced Network (iDEN), Wideband CDMA (WCDMA), High Speed Downlink Packet Access (HSDPA), High Speed Uplink Packet Access (HSUPA), and/or WiMAX.

The base station 60 includes a transmitter 84 and a receiver 86 for communicating with the mobile unit 52 and for communicating with hub station 62. The base station 60 also includes a signal processor 100 for processing signals sent between the mobile unit 52 and hub station 62. The base station 60 can use different protocols for communicating with the mobile unit 52 and hub station 62 over wireless links 66 and 70, respectively, but use the same transmitter and receiver, antenna 57, and feed-line 59 for each of those links. This saves substantial hardware cost, since one transceiver can be used where two would ordinarily be required, and substantial operational costs, since the same antennas and feedlines may be used, eliminating incremental tower lease costs (e.g., the incremental tower lease costs associated with microwave relays).

While the same communication standard could be used to communicate with the mobile and the base station (e.g., as disclosed in U.S. patent application Ser. No. 10/256,720 filed on Sep. 27, 2002) it is believed that using different communication standards, a more efficient spectrum utilization and/or lower deployment and operational costs are realized. This is because of the differences in the requirements for the communication link between the mobiles and base stations on the one hand and the base station and hub station on the other.

Since the location of the mobile unit 52 relative to the base station 60 varies as the user of the mobile unit 52 moves, a standard wireless protocol for communication with a mobile device typically includes many signal processing techniques to mitigate the variation in the signal caused by movement of the mobile. One effect of such variation is known as a rapid fade. Measures taken in a communication standard (and the device that implements the standard) to mitigate the impact of rapid fades might include incorporation of a diversity receive path, an adaptive equalizer and/or aggressive error correction coding. These measures can add cost to a product, reduce the product's data throughput, increase the latency of a transmission, reduce its battery life, increase its power consumption and/or even add size to a product.

In contrast, because the position of the hub station 62 relative to the base station 60 is fixed, a different communication protocol can be used for sending signals between the hub station 62 and the remote station 60 than is used for sending signals between the base station 60 and the mobile unit 52. Since the hub station 62 to base station 60 link does not experience the negative effects of mobility such as rapid fades, this protocol need not employ as aggressive signal processing methods in order to maintain a communication link. These methods may be used to extend the range of operation of the system, increase its throughput or increase the reliability of the link in the face of external sources of noise or disruption of the transmitted signal. On the other hand, if these performance enhancements are not required, the static nature of the base station 62 to hub station 60 link may be used to reduce the signal processing requirements and associated costs of the link.

In some embodiments, it is desirable to use different communication protocols for wireless links 66 and 70 because the communication requirements for these links are different. For example, the communication protocol used to communicate between the base station 60 and hub station 62 (e.g., wireless link 70) does not need to account for location varying performance in the link 70 as would be needed for communication between the mobile unit 52 and the base station 60 (e.g., wireless link 66). In addition, other factors associated with mobility such as the use of specialized signaling information intended to identify and authenticate the mobile unit 52 when it enters the coverage area of a particular base station is not necessary in a wireless link between fixed locations (e.g., such as in link 70).

As a result, if the communication link 70 between two fixed base stations (e.g., the base station 60 and the hub station 62) uses a communication standard meant for communication mobile devices, the communication will be sub-optimal with respect to spectral efficiency. Thus, when communicating with the hub station 62, the base station 60 uses a waveform that is different from the waveform used to communicate with mobile unit 52. This allows the use of a more efficient communication protocol for handling the wireless backhaul link 70 between the base station 60 and the hub station 62.

In some embodiments, the communication protocol used for wireless link 70 is a custom developed protocol. The protocol uses 100 kHz bandwidth for each half duplex channel (uplink and downlink), orthogonal frequency division multiplexing, trellis coding with 4 dB of coding gain and achieves raw data rates of approximately 300 kbps. In addition, upper layers of the protocol perform MAC address translation, Ethernet packet compression and routing. The protocol also employs rate adaptation to overcome jitter effects by buffering data and transmitting such data at scheduled intervals. This step is taken in order to ensure interfaces with other systems that require predictable information arrival times can interoperate with a general purpose processing environment where execution times are not managed in a deterministic fashion.

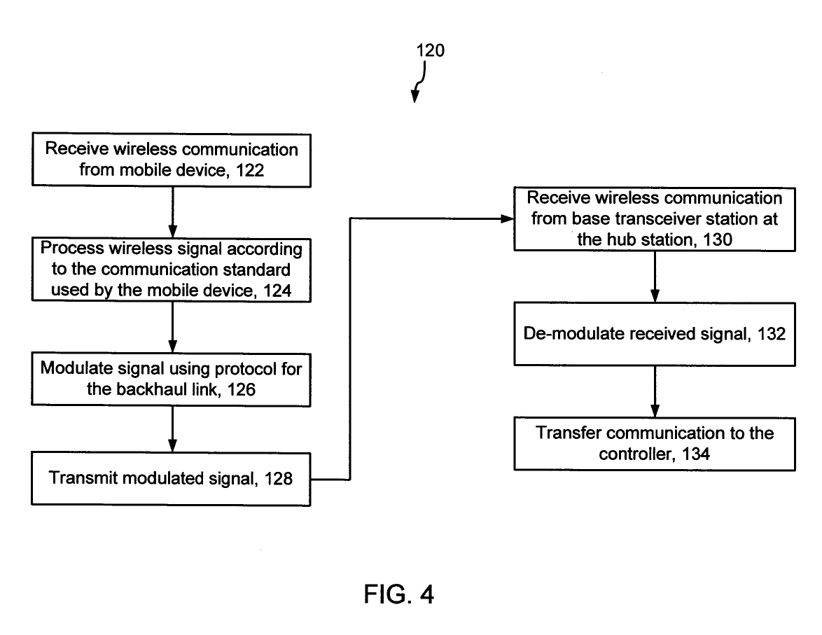

FIG. 4 shows a process 120 for using different communication protocols for signals sent between the base station 60 and the mobile unit 52 and between the base station 60 and the hub station 62. The base station 60 receives a wireless communication from the mobile unit 52 (122). The wireless communication can include a voice and/or a data transmission. More specifically, mobile unit 52 uses the transmitter 80 to transmit a wireless signal which is received by the receiver 86 of the base station 60.

After receiving the wireless signal from the mobile unit 52, the base station 60 processes the wireless signal according to the communication standard used by the mobile device (124). In some embodiments, the use of software based radios (for example, software radios such as those described in U.S. patent application Ser. Nos. 10/716,180, 11/071,818, 11/148,953, and 11/148,949, the contents of which are hereby incorporated by reference) can allow at least a portion of the functionality typically performed by a base station controller such as power control and/or timing advance to be performed by the base station 12. It can be beneficial to move such functionality to the base station 12 because it can reduce the backhaul bandwidth required by, for example, routing traffic that is local directly to its destination rather than employing backhaul resources to carry the traffic to the switch location and back to the serving cell.

The base station 60 modulates the signal using the protocol for communication between the base station 60 and the hub station 62 (126) and transmits the modulated signal using transmitter 84 (128).

Hub station 62 receives the wireless signal from the base station 60 using a receiver 104 (130). After receiving the wireless signal, hub station 62 de-modulates the signal (132) and transfers the signal to the base station controller 68 using a T-1 line 64 or other link (134).

In some embodiments, due to the link quality in the transmission of a signal over a wireless link 70 between the base station 60 and the hub station 62, various types of application level quality of service (QOS) and failure recovery can be desirable. In many real-time systems, TCP-style re-transmission is not appropriate, since the data may be too old by the time it is re-transmitted. Other approaches involve embedding error correction into the data stream so that lost packets can be reconstructed, and/or rules for dropping or repeating packets in the event of a loss.

One important parameter for a wireless communication is keeping the call alive (e.g., ensuring the transmission and receipt of signaling and control data used to maintain the call). In cellular systems, callers are accustomed to occasional drop outs or degradation in voice quality, but a dropped call can be a more significant problem.

In general, wireless communication protocols such as CDMA, TDMA, GSM, and iDEN are configured to expect a high bandwidth and low latency connection such as a T1 line, from the base station to the base station controller (e.g., as shown in FIG. 1). In contrast to the expected connection from the base station that receives the signal from mobile unit 52, system 50 introduces an additional wireless link 70 between a base station 60 and a hub station 62 (as shown, for example, in FIG. 2). Only after reaching the hub station 62, is the signal transmitted using a high bandwidth and low latency connection to the base station controller 68. The wireless link 70 has more noise than a T-1 line connection resulting in an increase in transmission errors compared to the case of a direct connection (e.g., a T-1 line) from the base station 60 to the base station controller 68.

In some embodiments, a retransmission protocol is used to increase the reliability of the wireless link 70 and reduce the frequency with which the wireless link 70 causes a loss of connection to the wireless call (e.g., reducing how frequently a cellular call is ‘dropped’ by the network). The retransmission protocol is based on an acknowledgement scheme in which the hub station 62 informs the base station 60 when a packet has been successfully received.

In order to implement the retransmission scheme, the wireless signals can be categorized into different classes which are used to determine whether or not to re-transmit a packet. The wireless traffic is categorized as signaling/control data or payload data. The signaling/control data is data used to maintain the call. Examples of such data include handover, power control and timing advance. If the signaling/control data is not received by the hub station 62 and retransmitted to the base station controller, the wireless link will fail and the mobile unit 52 will experience a dropped call. In contrast, payload data is data such as the voice data in a wireless call. If a portion of the payload data is not received successfully, the user of the mobile unit 52 may experience some noise in the call but the link typically will not fail. Since the signaling/control data is needed to maintain the call, the signaling/control data can be assigned a higher priority for retransmission than the payload data.

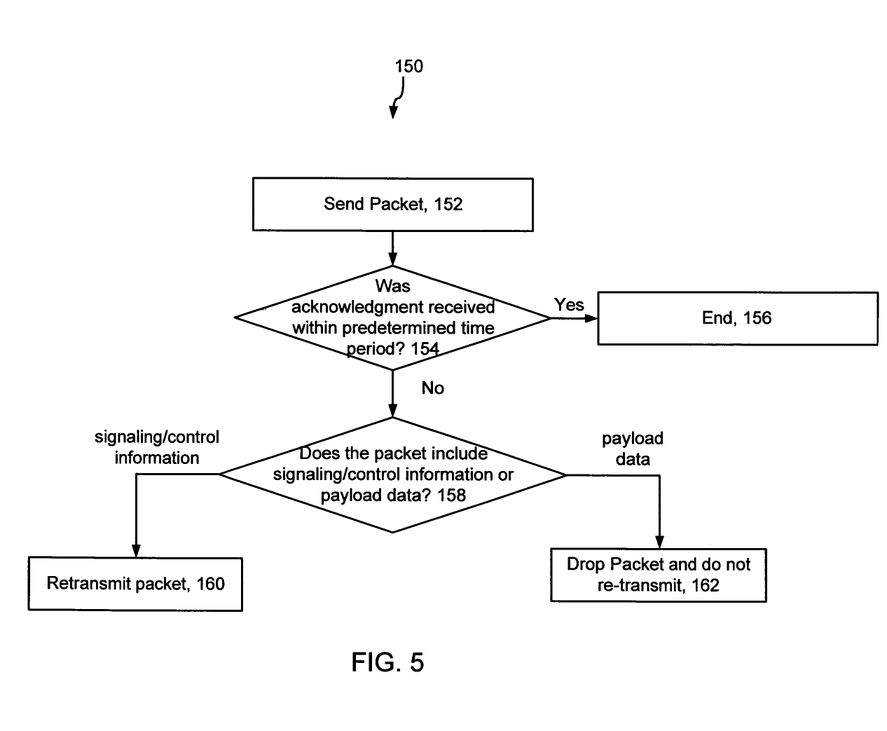

As shown in FIG. 5, in some embodiments, a retransmission process 150 is based on the retransmission priority assigned to the wireless signal to ensure that signals including signaling/control data are received such that the call is less likely to be dropped. Process 150 includes sending a packet from the base station 60 to the hub station 62 (152). If the packet is successfully received by the hub station 62, the hub station 62 sends an acknowledgement message to the base station 60. The base station 60 determines whether an acknowledgement message was received from the hub station 62 within a given time period (which is adjustable in order to vary with the distance between the hub station and base station as well as the transmission times required to send a packet based on hardware constraints, system settings (such as buffering) and available bandwidth) (154). If the acknowledgement was received, the base station 60 does nothing further with respect to transmission of that packet (156). If, on the other hand, an acknowledgement was not received, the base station 60 determines whether the packet included signaling/control data or payload information (158). If the packet included payload information, the base station 60 drops the packet without attempting to re-transmit the packet to the hub station 62 (162). If the packet included signaling/control information, the base station 60 retransmits the packet to the hub station 62 (160).

In addition to the re-transmission protocol described above, various other mechanisms can be used to ensure the latency and quality of the signal transmitted from the mobile unit 52 to base station controller 68 over the wireless links 66 and 70 is maintained. Since the wireless link 70 has higher latency and increased error rate compared to a T1 link, it can be beneficial to use various techniques to ensure that the quality-of-service (QoS) is maintained such that there is not an interruption in the voice service for the cellular customer. For example, the protocol implements a selective repeat procedure, which allows for a single retransmission of certain packets, in the event certain packets are not delivered error-free. An error-free delivery determination is made by reference to CRC (cyclic redundancy check) in the event of a packet that has arrived or with reference to timing requirements or packet sequence numbers in the event of a packet that fails to arrive.

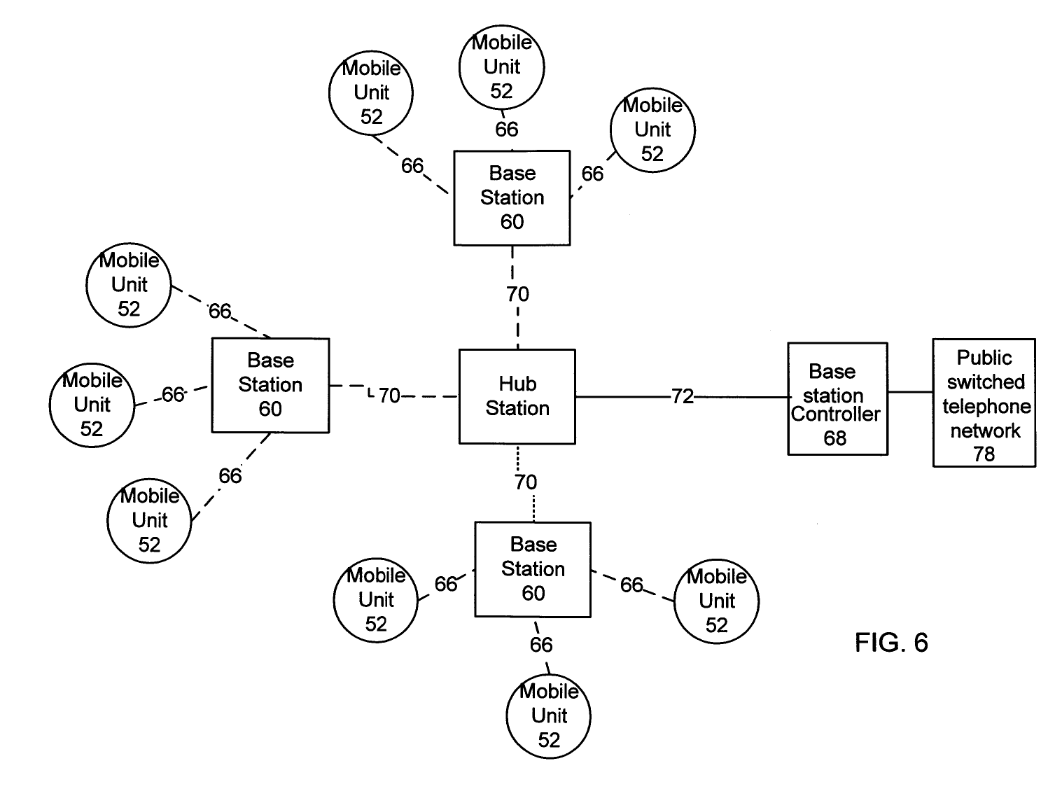

As shown in FIG. 6, a hub-and-spokes arrangement can be used to create a network of base stations 60 arranged about hub station 62. In such an arrangement, multiple mobile units 52 can communicate with a single base station 60 and multiple base stations 60 can communicate with a centralized hub station 62 over wireless backhaul link 70. In addition multiple hub stations can be connected to a single base station controller 68.

Such a hub-and-spokes arrangement can be beneficial because the overall area covered by the wireless system 51 can be increased without requiring as many wired connections. Since fewer wire-based communication links are needed, the cost of operating a hub-and-spokes based network 51 utilizing a wireless backhaul link 70 can be lower than operating multiple base station units each connected directly to the base station controller 68. Because the hub station 62 may be shared by many base stations 60 for backhaul of wireless signals, the cost of the link 64 from the hub station 62 to the base station controller 68 may be spread over a number of base stations 60.

For example, as shown in FIG. 6, the network 51 includes three base stations 60 connected using a wireless back haul link 70 to the hub station 62. In this arrangement only one wire-based connection is used (e.g., the connection 64 between the hub station 62 and the base station controller 68). If a traditional backhaul were used, three additional T-1 or microwave relay connections would be needed to connect each of the base stations 60 to the base station controller 68. Thus, the use of the in-band backhaul reduces the reduces the cost of operating such a network.

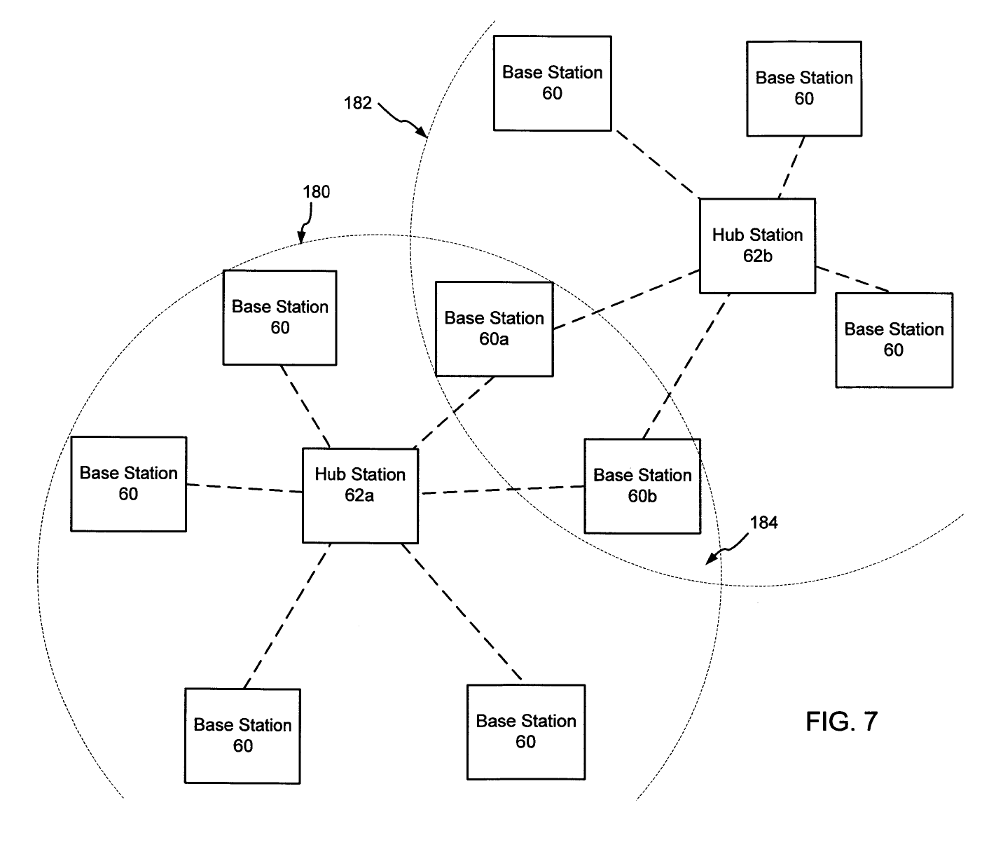

FIG. 7, shows an exemplary hub-and-spokes arrangement for multiple base stations 60 and multiple hub stations 62. Due to the positioning of the hub stations (62a and 62b), some of the base stations 60 may be within a range where communication is possible between the base station 60 and multiple different hub stations 62. For example, as shown in FIG. 7, the range of communication for hub station 62a (as indicated by dashed line 180) overlaps with the range of communication for hub station 62b (as indicated by dashed line 182) forming an overlap region 184. Base stations included in the overlap region 184 (e.g., base stations 60a and 60b) can communicate wirelessly with either hub station 62a or hub station 62b. This overlap increases the reliability of base stations 60a and 60b since a failure in either (but not both) hub station 62a or 62b need not result in failure of base stations 60a or 60b.

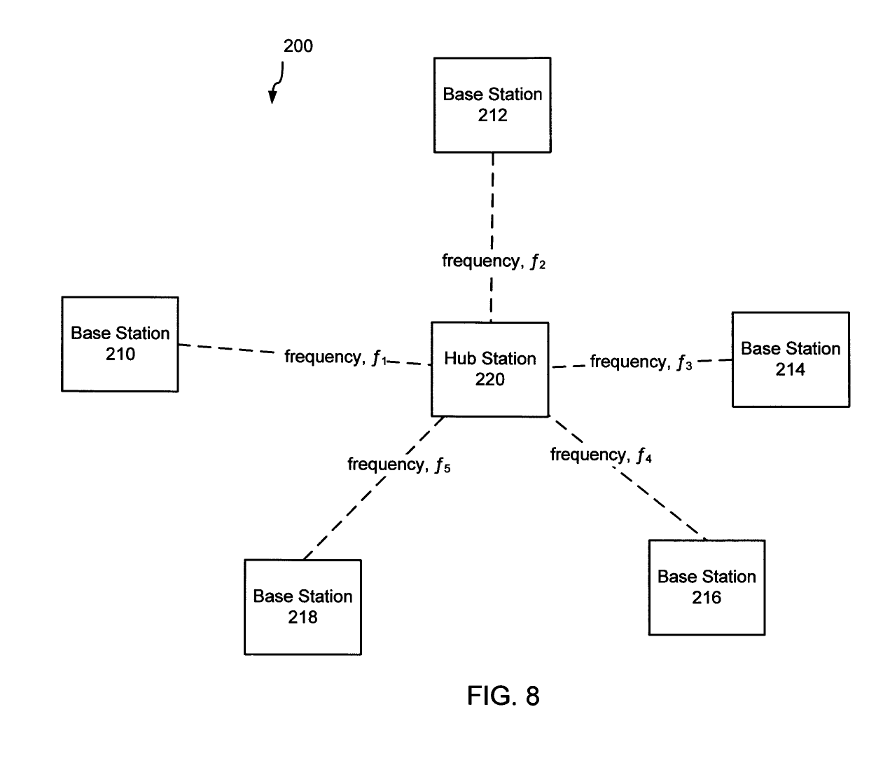

In some embodiments, as shown in FIG. 8, a backhaul system 200 can route information from a hub station 220 to different base stations (e.g., base stations 210, 212, 214, 216, 218) based on physical layer information such as transmission frequency. For example, different base stations can “listen to” and transmit on unique frequencies compared to other base stations. As shown in FIG. 8, base station 210 operates its in-band backhaul at frequency f₁, base station 212 operates its in-band backhaul at frequency f₂, base station 214 operates its in-band backhaul at frequency f₃, and so forth. Signals sent from hub station 220 at frequency f₁ are received and processed by base station 210 while signals sent from hub station 220 at frequency f₂ are received and processed by base station 212. Since each base station operates at a unique frequency (e.g., f₁, f₂, f₃, f₄, and f₅), the frequency of backhaul signal determines which base station (e.g., base stations 210, 212, 214, 216, and 218) receives the backhauled signal contained in the relevant signal.

Routing the backhauled information to a particular base station based on the frequency of transmission can reduce the latency caused by backhaul transmission compared to the use of a higher layer routing protocol. In general, a higher layer routing protocol would require, for example, demodulation of the signal to determine the address(es) to which individual packets are to be routed. This demodulation would result in a greater latency in comparison to routing the signal based on the frequency of the communication.

Because the waveforms, transmitters, and receivers employed to perform backhaul are software applications, it is possible to reallocate wireless resources, including backhaul resources, dynamically. Thus, it is possible to reallocate some or all communications channels and backhaul channels from an idle base station to another base station with additional capacity needs. For example, if no mobile stations were attached to base station 210, frequency f1 can be redirected to base station 212 to temporarily increase the capacity of base station 212.

In addition to frequency of operation, other examples of physical layer information that could be used to route the backhauled signals include: timeslot of transmission (on a shared channel), and/or orthogonal code in the case of a CDMA based backhaul system. Signals transmitted by the hub station 220 may be repeated at a base station in order for them to reach a further base station that is the addressee of the backhauled signal.

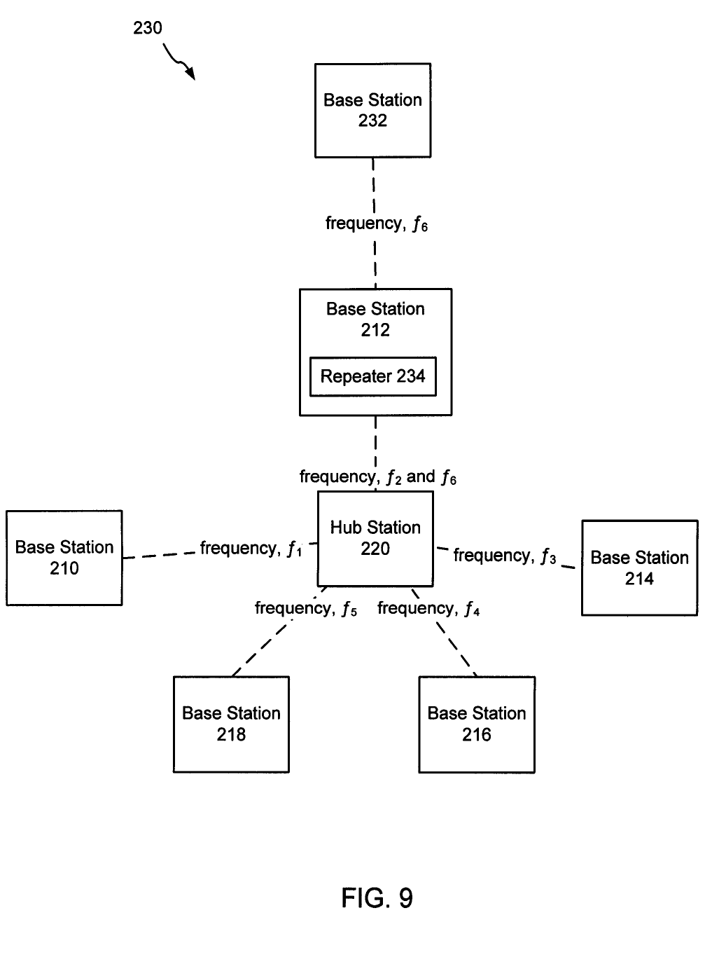

In some embodiments, as shown in FIG. 9, a backhaul system 230 can route information from a hub station 220 to different base stations (e.g., base stations 210, 212, 214, 216, 218, 232) based on physical layer information such as transmission frequency. One or more of the base stations can also act as a repeater station and forward a communications from the hub station 220 to another base station based on the physical layer information.

As shown in FIG. 9, base station 212 operates its in-band backhaul at frequency f₂ and base station 232 operates its in-band backhaul at frequency f₆. Since base station 232 is not in direct communication with the hub station 220, signals sent from hub station 220 at frequency f₆ are received by base station 212 and forwarded to base station 232 using a repeater 234. As such, base station 212 receives signals sent from the base station 220 at two different frequencies, e.g., frequency f₂ and frequency f₆. When base station 212 receives a signal at frequency f₂, base station 212 processes the signal. In contrast, when base station 212 receives a signal at frequency f₆, base station 212 sends the signal to base station 232 using repeater 234. Since base station 232 operates at a unique frequency that is different from the frequency at which base station 212 operates, the frequency of backhaul signal determines which base station (e.g., base station 212 or 232) receives and processes the signal.

The system can also manage jitter introduced into the system as a result of the backhaul transmission by buffering. For example, in some embodiments, the system can include a jitter buffer at one or both ends of the backhaul link to compensate for jitter in the shared network. In general, signal processing systems include some jitter which is a random variation in the time required to complete any particular task. At the lowest levels of the system, the jitter is due to hardware effects, such as the relative time at which two chips request access to a shared bus. At higher levels, the jitter comes from variable and unpredictable network performance. The jitter buffers can ensure that the system will continue to process signals and present them to the system users in accordance with the relevant communications protocol even when significant jitter exists in the network. The buffering employed in the protocol adapts based on performance of the link in question. Within limits, it will employ longer buffers if there is no data available for transmission out of the buffer at the scheduled time for transmission. On the other hand, if the system is performing well (no missed transmissions), the protocol will shrink the buffer in order to decrease end to end latency. The protocol may also employ methods for assigning priority to, and scheduling accordingly, the transmission of data out of its buffer in order to optimize overall system performance by minimizing the likelihood of collisions between packets transmitted simultaneously by multiple stations or by assigning higher priorities to certain packets (e.g., control packets) than other packets.

Other implementations are within the scope of the following

What is claimed is:

1. A method for backhaul of wireless transmissions, the method comprising:
wirelessly routing information to a particular base station of a plurality of base stations based on physical layer information.

2. The method of claim 1, wherein each base station of the plurality of base stations wirelessly communicates with a hub station using a unique frequency.

3. The method of claim 1, wherein the physical layer information comprises a transmission frequency.

4. The method of claim 1, wherein the physical layer information comprises a timeslot of transmission.

5. The method of claim 1, wherein the physical layer information comprises an orthogonal code.

6. The method of claim 1, wherein the physical layer information comprises a modulation method.

7. The method of claim 1, wherein the physical layer information comprises a transmission frequency and a time of transmission.

8. The method of claim 3, wherein routing information to a particular base station of a plurality of base stations based on physical layer information comprises:
receiving at the hub station a transmission from a base station controller;
determining which base station to route the transmission to by parsing an address included in the transmission;
determining a transmission frequency associated with the determined base station; and
routing the transmission to the determined base station using the determined transmission frequency.

9. The method of claim 1, wherein routing information to a particular base station of a plurality of base stations based on physical layer information comprises:
routing a first wireless transmission from a hub station to a first base station using a first frequency associated with the first base station; and
routing a second wireless transmission from the hub station to a second base station using a second frequency associated with the second base station, the second frequency being different from the first frequency.

10. The method of claim 1, wherein at least one base station of the plurality of base stations includes a repeater, the at least one base station of the plurality of base stations being configured to communicate with hub base station and to forward at least some wireless transmissions to another base station based on physical layer information.

11. A system for backhaul of wireless transmissions, the system comprising:
a hub station in wireless communication with two or more base stations, the hub station being configured to route wireless transmissions to the two or more base stations using two or more different frequencies, the two or more different frequencies being associated with particular ones of the two or more base stations.

12. The system of claim 11, wherein the hub station includes an input configured to receive transmissions from a base station controller using a wired communication link.

13. The system of claim 12, wherein the hub station is configured to:
receive a transmission from the base station controller using a wired link;
determine which base station of the one or more base stations to send the transmission to; and
send the transmission to the determined base station using a particular frequency associated with the determined base station.

14. The system of claim 11, wherein the hub station is configured to:
route a first wireless transmission intended for a first base station of the one or more base stations to the first base station using a first frequency; and
route a second wireless transmission intended for a second base station of the one or more base stations to the second base station using a second frequency, the second frequency being different from the first frequency.

15. A method for backhaul of wireless transmissions, the method comprising:
routing a first wireless transmission from a hub station to a first base station using a first frequency associated with the first base station; and
routing a second wireless transmission from a hub station to a second base station using a second frequency associated with the second base station, the second frequency being different from the first frequency.

16. The method of claim 15, further comprising:
receiving at the hub station a transmission from a base station controller;
determining which base station to route the transmission to by parsing an address included in the transmission;
determining a frequency associated with the determined base station; and
routing the transmission to the determined base station using the determined frequency.
